(19) United States
(12) Patent Application Publication
(10) Pub. No.: US 2021/0159840 A1
(43) Pub. Date: May 27, 2021

(54) MOTOR CONTROL UNIT ARRANGEMENTS AND COMPONENTS THEREOF

(71) Applicant: Silicon Mobility SAS, Valbonne (FR)

(72) Inventors: Mathieu Thomas, Vence (FR); Khaled Douzane, Grasse (FR); Bruno Salle, Marseille (FR)

(21) Appl. No.: 17/259,788

(22) PCT Filed: Jul. 8, 2019
(86) PCT No.: PCT/EP2019/068272

§ 371 Date: Jan. 12, 2021

(30) Foreign Application Priority Data
Jul. 13, 2018 (EP) 18183482.1

(51) Int. Cl. H02P 29/028; B60L 15/20; B60L 3/00

(52) U.S. Cl. CPC H02P 29/028; B60L 3/0061; B60L 15/20

(57) ABSTRACT

The invention relates to the field of motor control units, in particular those with a digital control system or unit comprising a matrix with a plurality of programmable logic units and/or being part of a platform, suitable for automotive, comprising an electric power train; and an electric power train management hardware, providing control for said electric power train, said management hardware comprising a heterogeneous hardware system comprising at least one software programmable unit (microprocessor core) and at least one motor control unit.

### FIELD OF THE INVENTION

The invention relates to the field of motor control units, in particular those with a digital control system or unit comprising a matrix with a plurality of programmable logic units and/or being part of a platform, suitable for automotive, comprising an electric power train; and an electric power train management hardware, providing control for said electric power train, said management hardware comprising a heterogeneous hardware system comprising at least one software programmable unit (microprocessor core) and at least one motor control unit.

### BACKGROUND TO THE INVENTION

Fault Detection Loop

In typical systems, the fault detection loop is managed in software by a processor core as follows:
The firmware periodically samples the values of the comparators outputs.
Whenever fault is detected on the comparators, the CPU has to break the algorithm that normally drives the control signals and force appropriate “safe” states on those signals.

There is several problems with this mechanism:
The fault reaction loop is managed sequentially by software. So, the delay between fault and safe mode application may be high. In powertrain application there may be safety issue because of this delay.

Also, in most system, the safe mode may not be applied simultaneously on all control signals. So, there will be intermediate periods of time where “in-complete” safe mode appears on the system. This can also be an issue for safety.

Boundary Scan Cells

As state-of-the-art, all digital integrated circuits like FPCU features some specific logic on I/O ports to enable board test execution as well as FPCU production tests. A traditional boundary scan chain consists of a daisy chain of small logic elements called “boundary scan cells”. The FIG. 13 gives the typical structure of this logic. Those elements are organized as one (or multiple chains) to allow control or bypass of any digital I/O of the FPCU as shown in FIG. 14. Important information to keep in mind is that there must not be any additional logic between each boundary scan cell and its associated device I/O pin. Another important information is that the state-of-the-art boundary scan cells are never used is functional operation. This logic is only for production test. The following drawing (FIG. 15) gives an example of a small portion of BSC chain that deals with two bidirectional pins of a digital integrated circuit. Below are the functional requirements of the state-of-the-art boundary scan cell:
“PO” output behavior requirements
   Functional mode.
      Each BSC can be configured so that “PI” input is combinatory transmitted to “PO” output.
      This is the normal mode of operation of the device (not in test mode)
   Test mode.
      Each BSC can be configured so that “PO” logic value is driven by the value stored in the “update” flip-flop on the BSC.
      This is a test mode. It allows to make system board connectivity tests:
         On pure input pins, this mode allows to freeze the logic signal entering the device logic core. Therefore, the internal logic is not influenced by test procedure happening on the system board.
         On pure output pins, this mode allows to drive a constant value towards the system board without involving complex action from internal logic core.
         On bidirectional pins, a set of three BSC allows to control the pin operating direction (ben′ pad control) and therefore permits to operates in either ‘input’ or ‘output’ directions. (see drawing above)
‘SI->SO’ scan chain behavior requirements
   “Shift-In and update” mode:
      The BSC can be configured to pre-load arbitrary logic values into the ‘shift’ flip-flop thanks to the shift register structure enabled by the daisy chain integration of all the BSCs of the integrated circuit (using clockDR signal as shift clock)
      Once all the logic values have been loaded into the shift flip-flops, they can be transferred to the “update” flip-flops with a single clock pulse on ‘updateDR’ signal.
   “Load and Shift-Out” mode:
      The BSC can be configured (with ‘shiftDR’ signal) so that a single clock pulse on ‘clockDR’ stores the ‘PI’ logic level into the ‘shift’ flip-flop.
      Then, the ‘shiftDR’ signal is toggled and all the loaded value can be read-out of the device thanks to the shift register structure enabled by the daisy chain integration of all the BSCs of the integrated circuit (using clockDR signal as shift clock).

As mentioned above, the eMachine system is functionally controlled through digital control signals generated by the MCU component. The following drawing (FIG. 16) summarizes the typical logic that actually generates this kind of signal. In the MCU, the control signal is generated from a storage element (flip-flop). Then this value optionally goes through additional logic (usually multiplexers that are transparent in nominal situation). Then the signal goes through the boundary scan cell that is set to “bypass” mode. When the system detects a fault, then the output pin must be set in a “safe” state. Whatever the sequence, sooner or later this safe state should be stored in the above flip-flop. In this case, the safe level still goes through the optional logic and the BSC. This is not the safest situation because those extra elements may be subject to random fault events that would further corrupt the safe value applied on the control signal.

### Aim of the Invention

The aim of the invention is to provide fault handling in the context of eMachines, such fault handling being fast and/or having sufficient diagnostic capabilities and/or sufficient fault containment possibilities.

The goal of the current invention is to propose an efficient solution to the problem mentioned in the background of the invention while permitting to optimize the cost of the system by reducing the number of analog comparators.

The current invention ensures that the safe control signal value can be stored as near as possible to the MCU pin by providing a safe boundary scan cell.

### SUMMARY OF THE INVENTION

An aspect of the invention relates to a motor control unit (MCU), suited for control of an electrical motor (via control signals, comprising: a digital control unit with one or more output ports; characterized in that to at least one of said output ports a safety component is provided, said safety component being capable of providing a predetermined safe value, stored therein, upon receipt of a fault signal (derived from measurement signals); and otherwise providing the output provided by said digital control unit (to said electrical motor).
In an embodiment of the invention said safety component comprises: a switching means (multiplexer); connected to said output ports and to a storage unit (flip flop) for storage of said predetermined safe value; said switching means being controlled by said fault signal; and said storage means being adapted for receiving said predetermined value either directly (as shown) or indirectly.
In an embodiment of the invention said safety component is part of a so called boundary scan cell and capable of temporally storage (in a (further) storage unit (flip flop)) of the value of said output port, for subsequent read-out on demand.
In a particular embodiment of the invention one or more additional scanning possibilities are provided by providing additional feedback signals and/or, originating respectively from (the output of) said switching element and (the output of) said memory element to said (further) switching element.

An aspect of the invention relates to safety components as described above.

An aspect of the invention relates to fault management units, capable of operating those safety components.

An aspect of the invention relates to joint operating methods of said safety components by use of a test management unit and fault management unit.

An aspect of the invention relates to a motor control unit (MCU), suited for control of an electrical motor (via control signals), comprising: (1) a digital control system (optionally any of those discussed above) with one or more output ports; and (2) a fault management unit (separate from said digital control system), adapted for steering said digital control system by fault signals, derived from measurement signals, the fault management unit being characterized that at least two of said measurement signals are simultaneously used in determining said fault signals.

Another aspect of the invention relates to a motor control unit (MCU), suited for control of an electrical motor (via control signals), comprising: (1) a digital control system (optionally any of those discussed above) with one or more output ports; and (2) a fault management unit being characterized that as part of determining or deriving fault signals from measurement signals, for at least one of said measurement signals N(>=2) signal level thresholds are detected by use of a dedicated single comparator, fed by a variable (N(>=2) signal levels) reference signal generator, whereby the obtained detections (and reference signal behavior) is used in a fault management subunit, capable of deriving said fault signals therefrom.

The invention relates to methods executed by the involved fault management unit, test control unit and related computer programs supporting such methods.

### BRIEF DESCRIPTION OF THE DRAWINGS

FIG. 1 shows a schematic motor control unit arrangement with a dedicated safety component according to the invention.

FIG. 2 shows a variety of such dedicated safety components according to the invention.

FIG. 3 shows a particular interconnection of such dedicated safety components.

FIG. 4 shows a schematic motor control unit arrangement, capable of determining fault actions based on at least two measurement signals.

FIG. 5 shows a schematic motor control unit arrangement, capable of determining two or more levels on a measurement signal with use of a dedicated comparator.

FIG. 6 shows a schematic motor control unit arrangement with an architecture of the fault management unit.

FIG. 7 provides an exemplary embodiment of the aspect of FIG. 1.

FIG. 8 provides an exemplary embodiment of the aspect of FIG. 5.

FIG. 9 illustrates the typical signals encountered when dealing with fault and related level detection.

FIG. 10 provides an exemplary embodiment of the aspect of FIG. 6.

FIG. 11 illustrates the typical signals encountered when dealing with fault and related level detection.

FIG. 12 provides an exemplary embodiment of the aspect of FIG. 6, more in particular the reference level generation.

FIG. 13, 14, 15 shows prior-art boundary scan cell arrangements.

FIG. 16 illustrates the arrangement for which the invention provides a solution.

FIG. 17 provides an exemplary embodiment of the invented boundary scan cell as discussed in the aspects of FIGS. 1, 2 and 3.

FIG. 18 describes an exemplary embodiment wherein the invented boundary scan cells are used under control of both the fault management control and test management units.

FIG. 19 describes schematically an arrangement with a safety components of the invention used on the input side of the digital control engine.

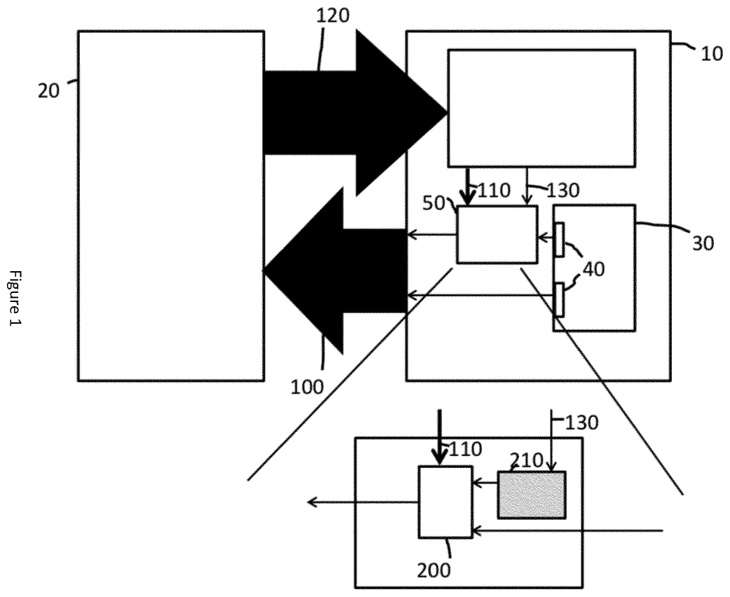

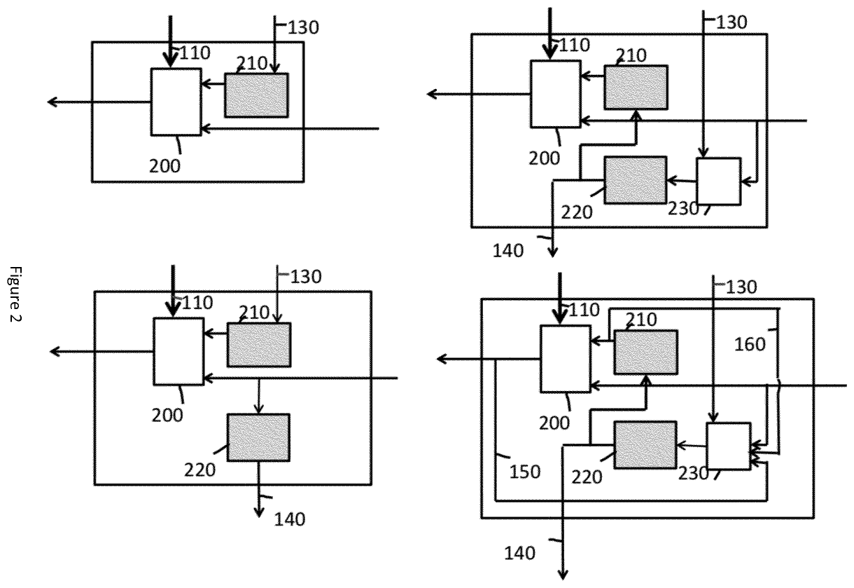

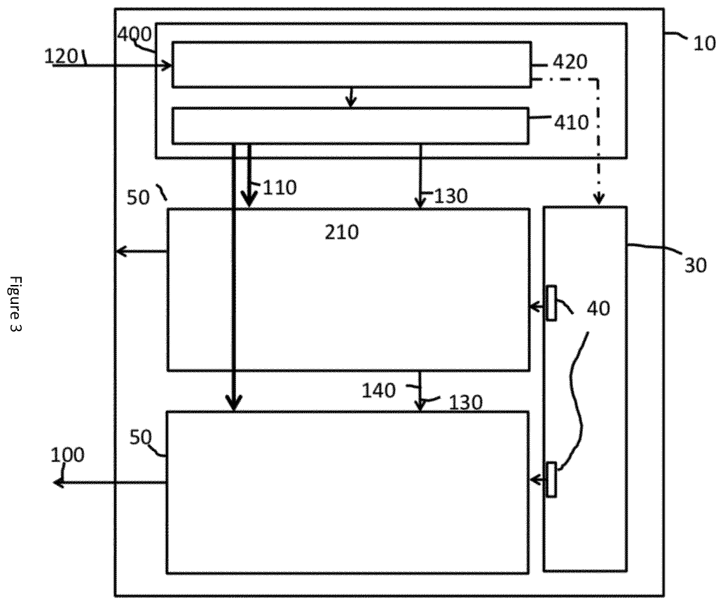

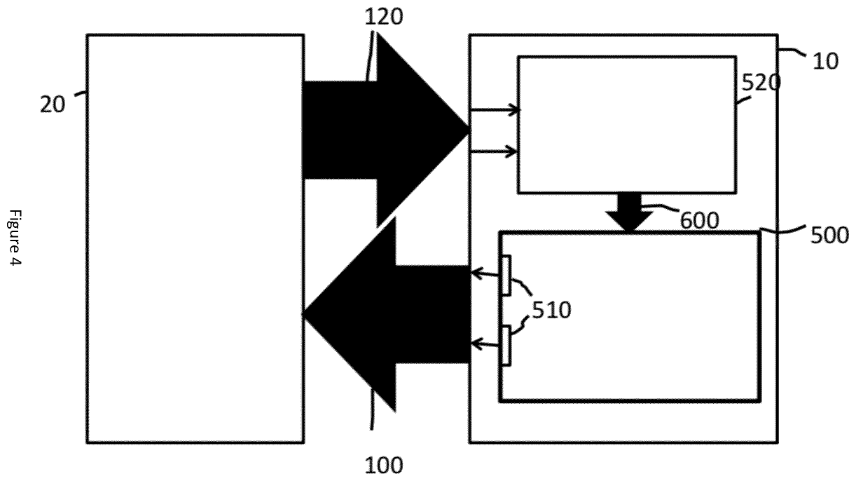

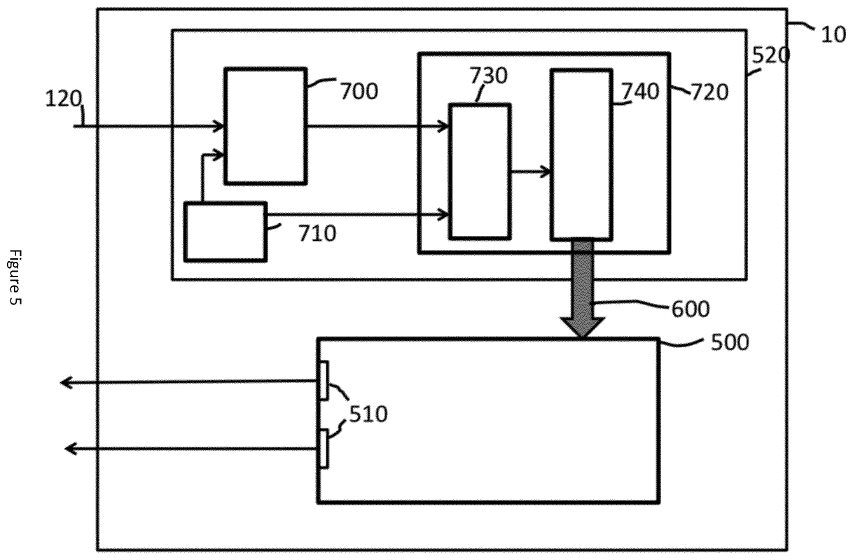

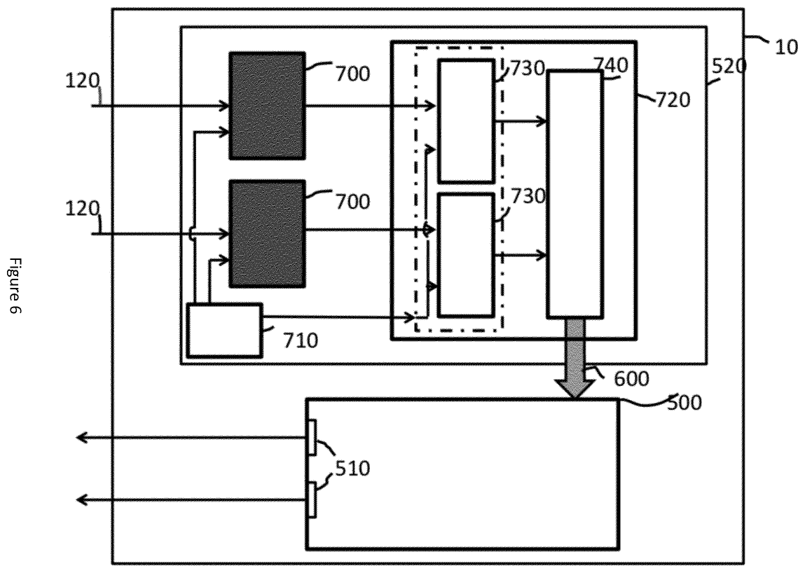

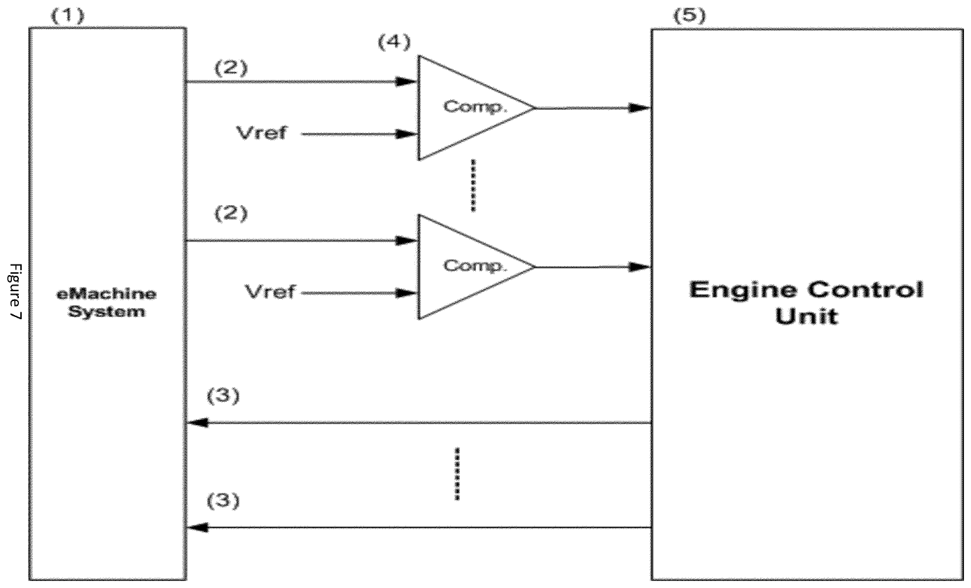

### DETAILED DESCRIPTION OF THE INVENTION

The invention relates to motor control unit arrangements specifically adapted for providing extra safety in case errors or faults occur. The invention provides a variety of such dedicated safety components and interconnections thereof. The invention provides further architectures for such arrangement, enabling to take benefit of at least two or more measurement signals while being hardware cost efficient by providing an arrangement for determining two or more levels on a measurement signal with use of a dedicated comparator. The invention finally also provides adapted architectures of the fault management unit and describes the integration of the new safety component with test management units used within the motor control unit.

Application

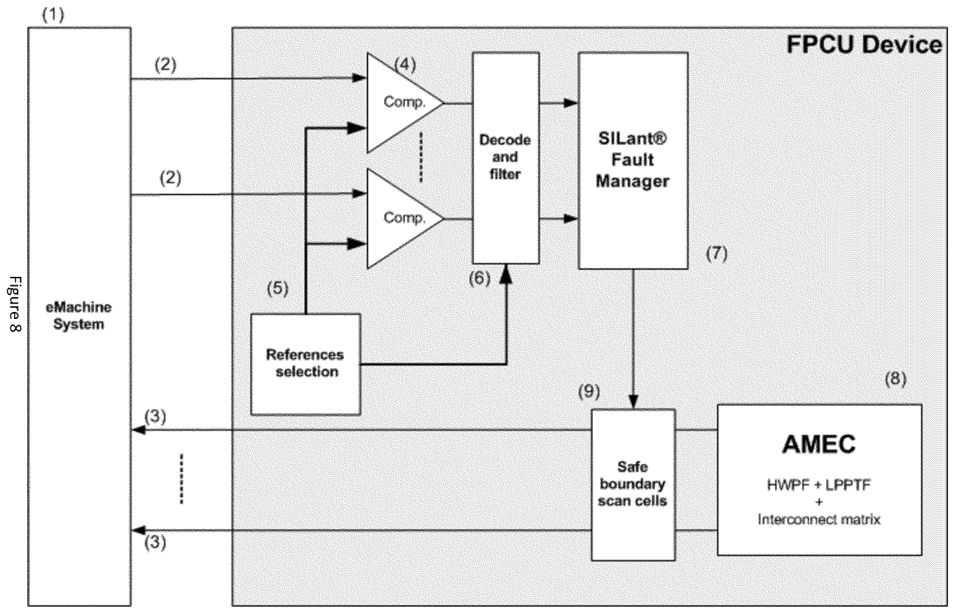

As said, the invention applies to electric engine digital control domain. In particular it is targeting (but not limited to) control of pure electric or hybrid vehicle electric motors. The invention aims to provide fast system fault detection and associated safe mode setting. The invention takes place in a system defined as in FIG. 7, having
1) An electric machine system (motor, voltage converter, charger, . . . )
2) Some electric values (voltage or current) measured from the previous system.
3) Some digital signals responsible for controlling the functional activity of the electric system
4) A set of voltage comparators that permit to compare the measure values to pre-defined levels.
   (note: depending of the embodiment, those comparators may also be integrated in following ECU)
5) An engine control unit (ECU) that generate the digital control signals and sample the comparators output.

In the nominal situation (i.e: no system fault), the measures values are within nominal value ranges. Therefore, all the comparators outputs are ‘inactive’. Whenever one of the measured signals is crossing allowed range (defined by Vref values), we can assume that something went wrong in the electric system. In this situation the ECU should react as fast as possible in order to put the control signals (3) in a “safe” state

System Overview

In the current invention, the previous application system can be detailed as follows.

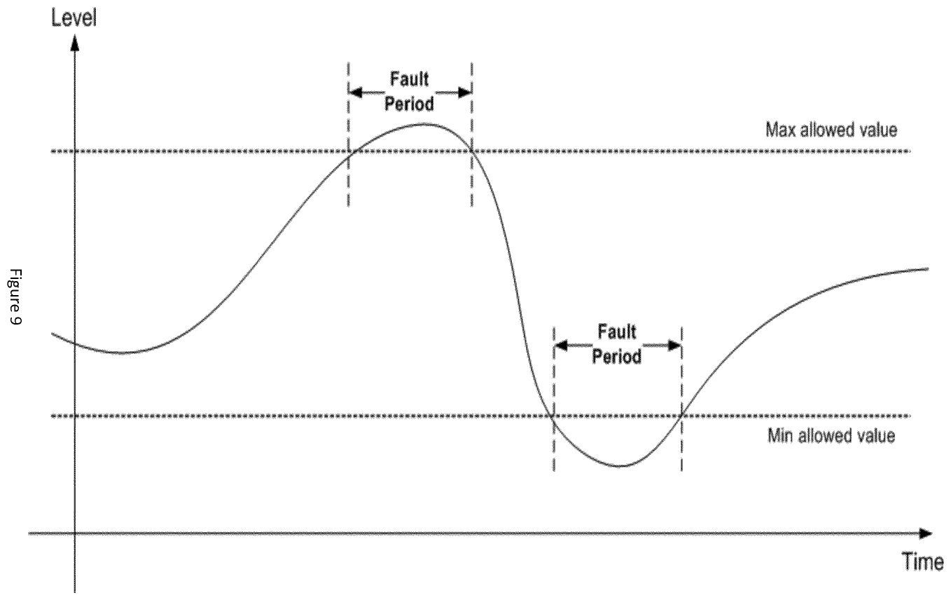

This system relies on a specific engine control unit device called: FPCU. This kind of component is based on a specific architecture comprising of the so-called AMEC and SILant fault manager as further detailed in FIG. 8.

The system consists of the following elements:
1) An electric machine system (motor, voltage converter, charger, . . . )
2) Some electric values (voltage or current) measured from the previous system.
3) Some digital signals responsible for controlling the functional activity of the electric system
4) A set of embedded analog comparators able to compare the previous measured values (2) to some dynamically generated (or selected) reference voltages.
5) A logic function able to dynamically generate (or select) the previous reference voltages.
6) A decoding logic that reconstructs the comparison results in synchronism with previous reference voltage generator and further generates the fault detection signals accordingly.
7) The SlLant® Fault Manager able to automatically compute the previous errors into safe state.
8) The AMEC® sub-system responsible for generating the electric system control signals in “nominal” situation (i.e: no fault).
9) The “Safe boundary Cells” that permit to transmit the functional control signals from AMEC in nominal mode or immediately switch those signals in pre-defined safe state on fault manager order.

Dynamic Reference Comparators

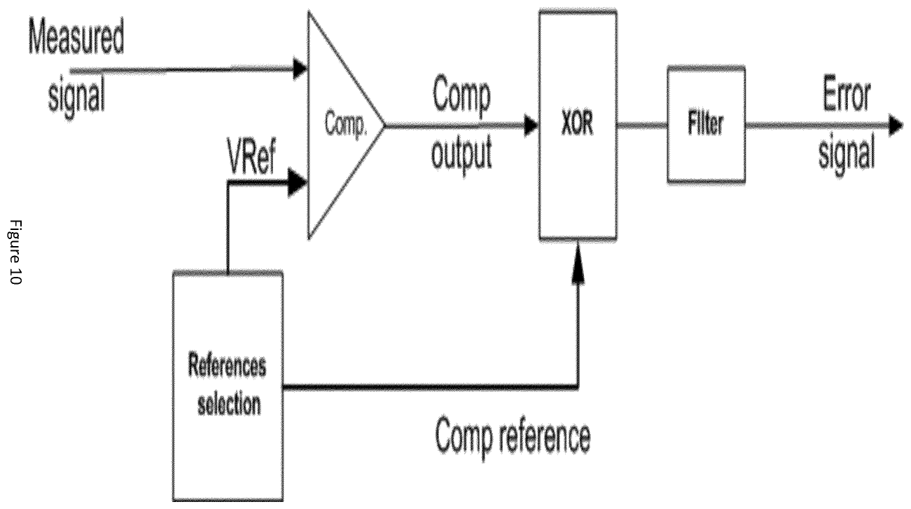

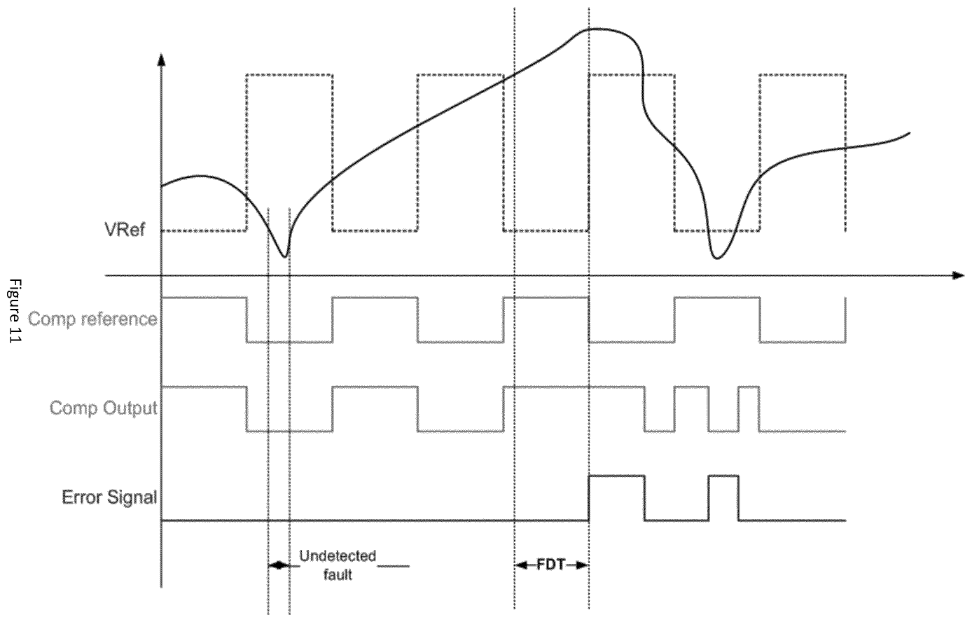

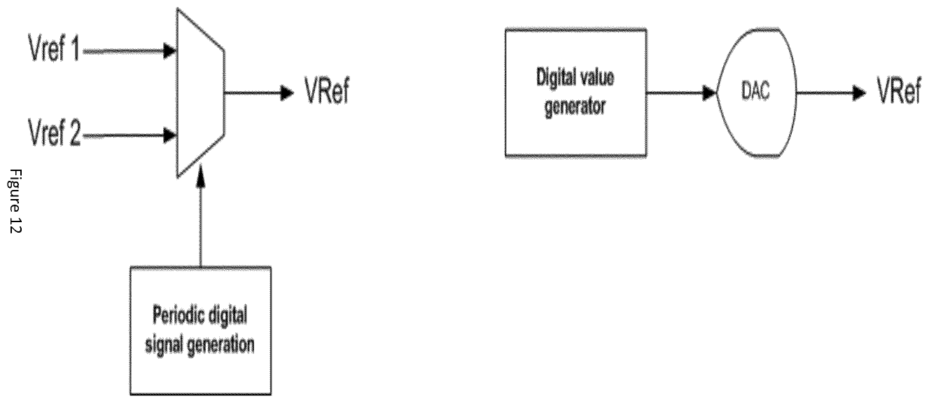

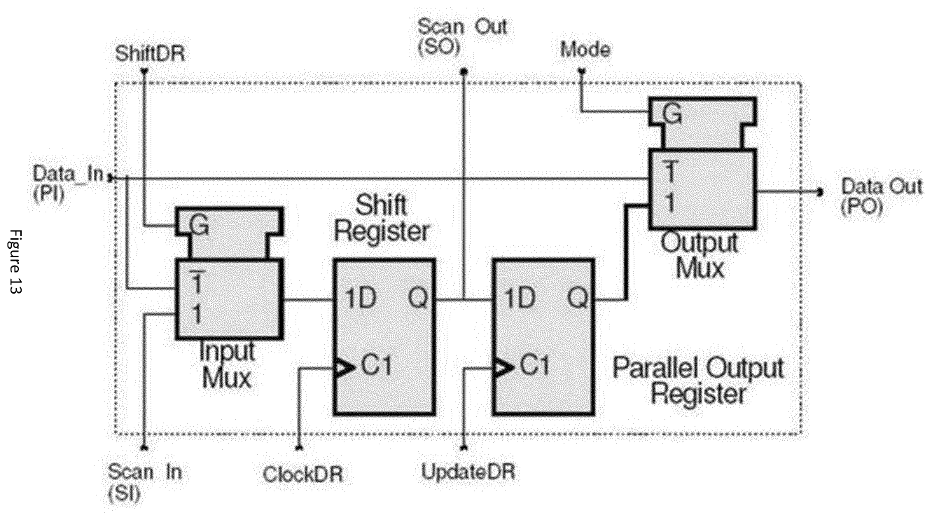

In many cases, monitoring the correct level of a measured signal consist in checking that it continuously remains within a specific range, as shown in FIG. 9. The standard structure to handle this kind of checking consists of two comparators in parallel (one for the max value, and one for the min value). In this invention as shown in FIG. 10 we propose to handle both comparison with a single comparator using time shared principle and proper sequencing. The diagram of FIG. 11 explains the behavior of this logic over time. The ‘filter’ function on error signals are preferred to filter-out glitches on the signal during Vref switching transition phases.

Fault Detection

Compared to the state of the art solution (using two parallel comparators) the proposed solution may have some drawbacks that must be analyzed carefully.
1) The maximum fault detection time (FDT) is equal to the period of the VRef switching rate (whereas the state of the art solution has a theoretical FDT equal to 0).
2) When measured voltage is faulty for a delay that is less that VRef switching period, there is 50% chances that this fault is not detected by the system.

Those potential drawback are usually not a problem because the measured signals are typically much slower than the VRef switching frequency.

There may be multiple technical solutions for generating the VRef comparison level.

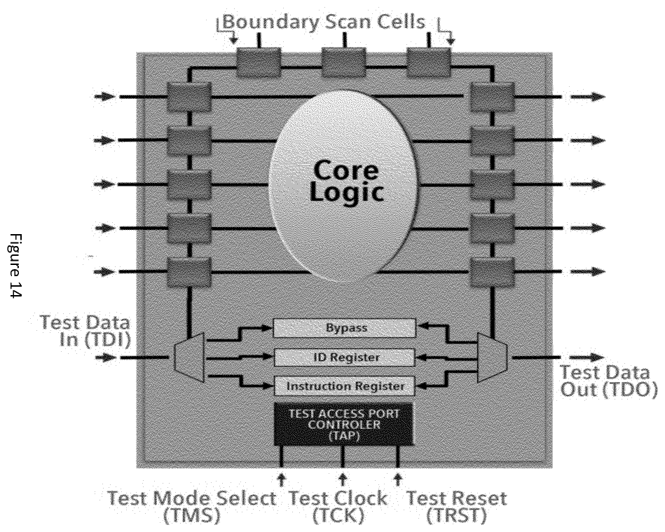

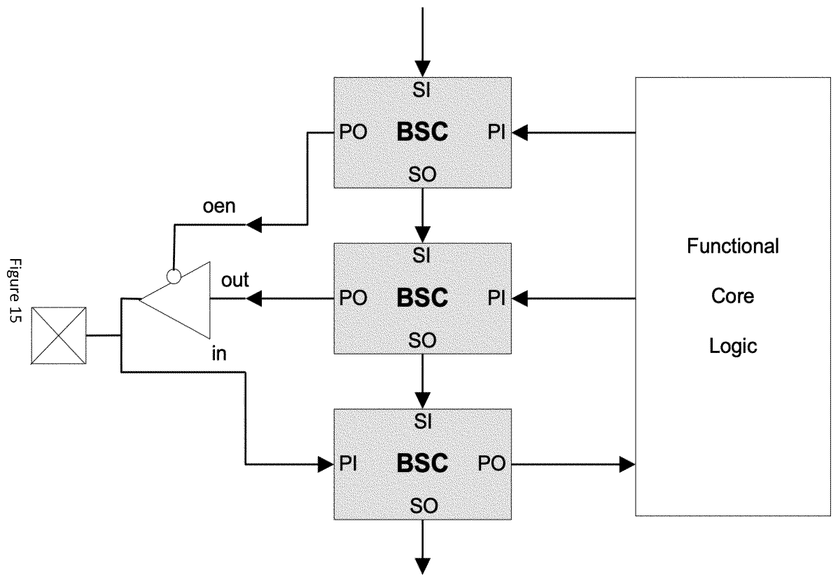

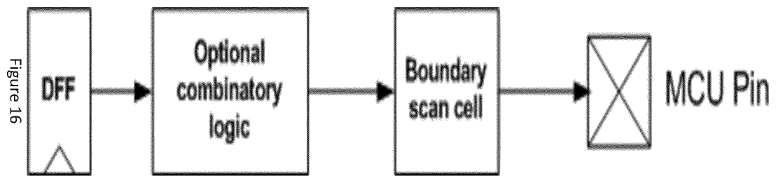

In FIG. 12 we present two possible embodiments of the VRef generation module:

Voltage Reference Detection or Selection

Exemplary embodiments are shown in FIG. 12.

First solution is based on an analog multiplexer that selects one over two constant reference voltages. The multiplexer selection is a periodic digital signal (clock, PWM, . . . ). Usually, the input reference voltages are created outside the FPCU component (one the system board)

Second solution offers much more flexibility. It is based on a Digital to Analog Converter (DAC) whose input digital value is changed periodically by a dedicated logic.

Safe Boundary Scan Cell

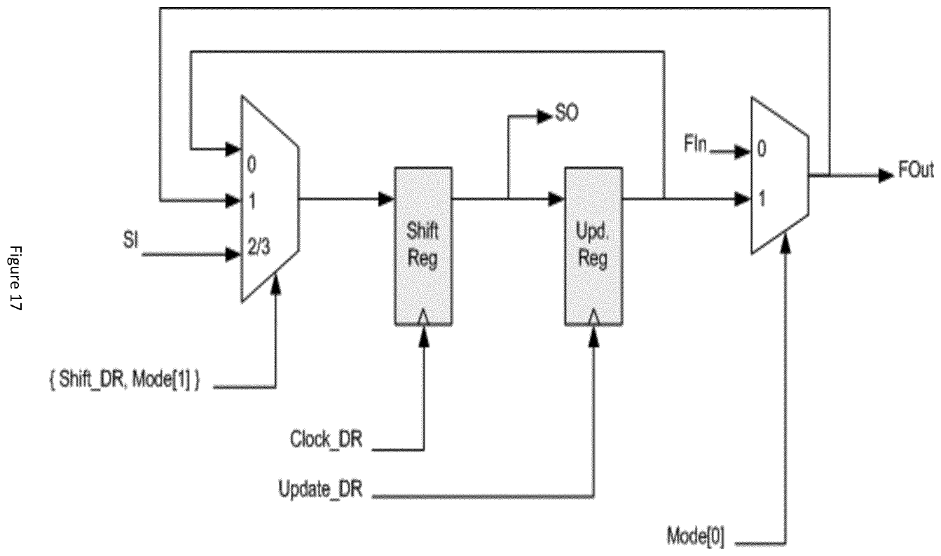

The following drawing (FIG. 17) describes the “Safe BSC” micro-architecture.

In addition to the state-of-the-art BSC requirements presented earlier, the following additional requirements are needed as an invention to transform the standard BSC into a patentable ‘safe-BSC’:
The BSC is now usable in operating mode (not only in test mode). Therefore, the control signal should be driven not only by the JTAG interface (standard) but also by the FPCU fault manager (see earlier)
Safe mode load and shift-out
   This is a requirement of the ISO26262 standard that requires that all the safety mechanism should be checked regularly during functional operation mode. Therefore, it must be possible to check the content of the ‘update’ registers of all the safe-BSC of the device against their original value to verify that no flip-flop content has been corrupted over-time.
   This checking must be done at run-time. Therefore it must not impact the functional mode of the SBSC (i.e: combinatorial path from PI to PO)
   Thanks to ShiftDR and mode[1], it is possible to transfer the content of ‘update’ flip-flop to ‘shift’ flip-flop with one updateDR clock pulse.
   Then the state-of-the-art daisy chain in used to shift-out all the values out of the safe-BSC of the FPCU.
   It is the responsibility of the fault management logic to compare the actual value to the initially programmed value.

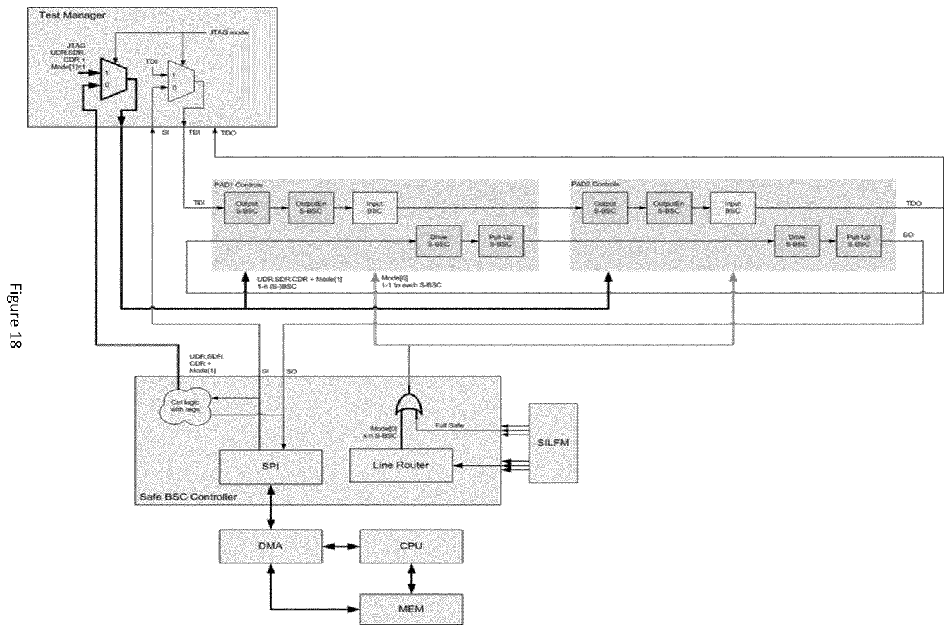

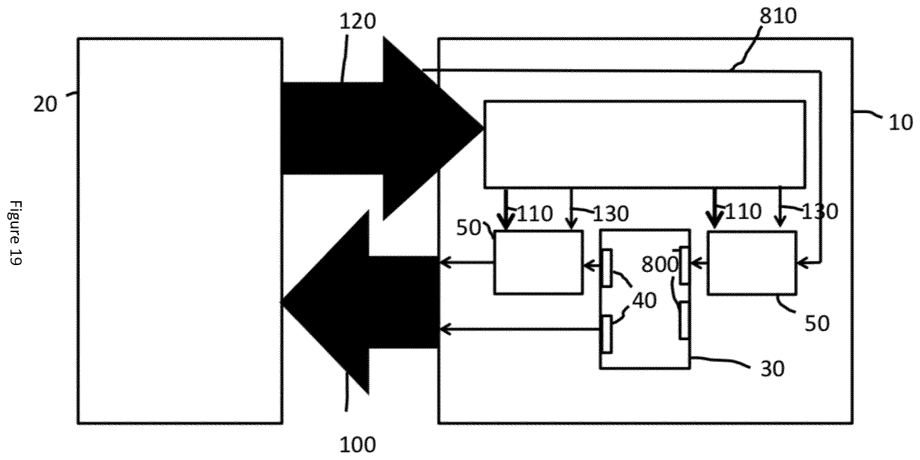

The following drawing (FIG. 18) explains a typical integration of safe BSC in an FPCU component:

Safe Boundary Scan Cell Chains and Operating Sequences

As state-of-the-art, the safe SCB are arranged in one or multiple daisy chains. Please note that the daisy chains may contain a mix of regular and safe BSCs.

The integration features two BSC control modules:
The test manager which is responsible for the state-of-the art management of the boundary scan chains (including safe BSCs). This test controller is only active during FPCU production test. It shall not interfere with functional operation.
The Safe BSC controller that has three different roles:
   Shift-in the safe state values into the safe BSC chain(s). The safe values are normally stored in the FPCU non volatile memory. Please note that the memory may feature multiple different safe state tables that the application shall select according to its needs. The role of the controller is therefore to transfer the safe state data from memory to BSC chain. In the proposed embodiment this is done by means of DMA transfer through SPI interface.
   Shift-out and check the currently programmed safe state. Indeed, the functional safety good practices requires that the programmed safe state be verified regularly during functional operation (i.e non intrusive). The BSC is also responsible for that.
   Switch the safe BSC in safe mode based on request from SILant fault manager.

Fast Fault Detection Sequence

If we summarize the sequences of operations starting from a fault occurring to the effective safe state applied we have:
The switched comparator fault detection whose fault detection time is bounded to VRef switching period
The error event handling through Fault manager which is a matter is few clock cycles.
The application of the safe state on safe BSC which is one more clock cycle.

So, with the invention, the complete fault reaction time is a matter of few 10's of clock cycles. As compared to several thousand when using state-of-the art software managed fault reaction.

1-16. (canceled)

17. A motor control unit adapted to control an electrical motor, the motor control unit comprising:
a digital control unit having one or more output ports; and
a safety component provided to at least one of the output ports, wherein the safety component:
provides a predetermined safe value upon receipt of a fault signal derived from measurement signals, the predetermined value being stored in the safety component; and
otherwise provides to the electrical motor an output provided by the digital control unit,
wherein the safety component comprises a switching means connected to the output ports and to a storage unit that stores the predetermined safe value, the switching means being controlled by the fault signal, the storage unit being adapted for receiving the predetermined value either directly or indirectly.

18. The motor control unit of claim 17, wherein the safety component is part of a boundary scan cell and is capable of temporarily storing the value of the output port in a further storage unit for subsequent read-out on demand.

19. The motor control unit of claim 18, wherein:
a plurality of the output ports are provided with boundary scan cell integrated safety components connected in a daisy chain;
the safety components further comprise a further switching element connected to the output ports and to the storage unit; and
the storage unit and the further storage unit are connected.

20. The motor control unit of claim 19, wherein the output of the switching element and the output of the memory element to the further switching element provide the motor control unit with one or more additional scanning possibilities by providing additional feedback signals.

21. The motor control unit of claim 19, further comprising:
a fault management unit comprising a fault detection logic unit; and
a controller that generates clock and/or switching signals and/or update signals for the safety components, the fault detection logic unit steering the controller and optionally also the digital control unit.

22. The motor control unit of claim 21, wherein the controller is adapted for being steered by a test management unit for exploiting scanning capabilities of the boundary scan cells.

23. The motor control unit of claim 17, wherein the digital control unit comprises a matrix with a plurality of programmable logic units.

24. The motor control unit of claim 17, wherein the storage unit is a one-bit clocked storage element.

25. The motor control unit of claim 17, wherein the digital control unit further comprises one or more input ports, the motor control unit further comprising:
a safety component provided to at least one of the input ports, wherein the safety component:
provides a predetermined safe value upon receipt of a fault signal derived from measurement signals, the predetermined safe value being stored in the safety component provided to the at least one of the input ports; and
otherwise provides to the digital control unit an input derived from the measurement signals.

26. A platform adapted for an automotive having an electric power train, the platform comprising:
an electric power train management hardware that controls the electric power train, the electric power train management hardware comprising a heterogeneous hardware system comprising at least one software programmable unit and at least one motor control unit according to claim 17.

27. A motor control unit adapted to control an electrical motor via control signals, the motor control unit comprising:
a digital control system having one or more output ports; and
a fault management unit separate from the digital control system and adapted for steering the digital control system by fault signals derived from measurement signals, wherein at least two of the measurement signals are simultaneously used in determining the fault signals.

28. The motor control unit of claim 27, wherein the digital control system comprises a matrix with a plurality of programmable logic units.

29. The motor control unit of claim 27, wherein the storage unit is a one-bit clocked storage element.

30. A motor control unit adapted to control an electrical motor via control signals, the motor control unit comprising:
a digital control system having one or more output ports;
a fault management unit comprising at least one fault management subunit; and
a dedicated single comparator, fed by a variable reference signal generator, wherein as part of determining or deriving fault signals from measurement signals, for at least one of the measurement signals, N signal level thresholds are detected by the dedicated single comparator, and the fault management subunit derives fault signals from the obtained detections and reference signal behavior.

31. The motor control unit of claim 30, wherein the fault management subunit comprises a plurality of fault management subunits, the fault management subunits each being related to an individual measurement signal, the fault management subunits determining the fault signals from inputs received from at least two fault management subunits.

32. The motor control unit of claim 30, wherein the digital control system is adapted so that, upon receipt of the fault signal, a predetermined safe value stored in the digital control system is provided to at least one of the output ports and so that, without receipt of the fault signal, digital output computed by the digital control system is provided to the electrical motor.
